(19) United States
(12) Patent Application Publication
(10) Pub. No.: US 2026/0136098 A1
(43) Pub. Date: May 14, 2026

(54) METHOD AND SYSTEM FOR OPTIMIZING AUTO-FOCUS FUNCTIONALITY FOR CAPTURING A MULTIMEDIA CONTENT

(71) Applicant: Samsung Electronics Co., Ltd., Suwon-si (KR)

(72) Inventors: Avijit BORAH, Noida (IN); Pratul KUMAR, Noida (IN)

(21) Appl. No.: 19/441,185

(22) Filed: Jan. 6, 2026

Related U.S. Application Data
(63) Continuation of application No. PCT/KR2024/014424, filed on Sep. 25, 2024.

(30) Foreign Application Priority Data
Oct. 11, 2023 (IN) 202311068482

(51) Int. Cl. H04N 23/67; G06V 10/77; H04N 23/61; H04N 23/667

(52) U.S. Cl. CPC H04N 23/675; G06V 10/7715; H04N 23/61; H04N 23/667

(57) ABSTRACT

A method and a system for optimizing auto-focus functionality for capturing a multimedia content are provided. The method includes detecting, by an object detection module, one or more objects in a preview frame of the multimedia content, performing, by a feature extraction module, a plurality of functions for extracting attributes of the detected one or more objects, computing, by a priority assignment module, occupancy factor and popularity factor of each detected object are computed to determine priority score, identifying, by a focus identification module, a suitable focus mode and a focus area mode for each selected object are identified based on extracted attributes. In one embodiment, the selected object includes all the detected objects that have a priority score greater than or equal to a predefined threshold value, and applying, by a frame capture and combining module, the identified focus mode and the focus area mode are applied on each selected object for providing the multimedia content.

### CROSS-REFERENCE TO RELATED APPLICATION(S)

This application is a continuation application, claiming priority under 35 U.S.C. § 365 (c), of an International application No. PCT/KR2024/014424, filed on Sep. 25, 2024, which is based on and claims the benefit of an Indian Patent Application number 202311068482, filed on Oct. 11, 2023, in the Indian Intellectual Property Office, the disclosure of which is incorporated by reference herein in its entirety.

### BACKGROUND

### 1. Field

The disclosure relates to multimedia content capturing devices. More particularly, the disclosure relates to a system and method for optimizing auto-focus functionality for capturing a multimedia content.

### 2. Description of Related Art

Autofocus (AF) is a critical feature in multimedia content capturing devices, such as cameras, that ensures the selected area or object, whether chosen manually or automatically, appears sharp within multimedia content, such as an image or video. This is accomplished by using different image sensors that detect distance between the object or selected area and the camera, and the lens, which adjusts its focal distance using an electronic motor based on the image sensor's information.

Currently, autofocus is primarily achieved through two methods contrast detection AF and phase detection AF. The contrast detection AF involves measuring contrast within the sensor field by utilizing the lens. By analyzing the intensity disparity between neighboring pixels on the image sensor of the multimedia content capturing device, the correct focus distance is determined. The optical system is subsequently adjusted until the maximum contrast is detected, resulting in a sharp image.

In contrast, phase detection AF relies on phase discrepancies between two points on the image sensor to ascertain the focus distance. The image sensor of the multimedia content capturing device is partitioned into two distinct areas, with each area responsible for measuring the phase difference between the incident light and the light reaching the other area. This acquired information is then utilized to determine the area of focus for the lens, ultimately resulting in a sharp and well-defined image.

However, these existing autofocus methods primarily consider basic parameters, such as face and eye detection or objects positioned near the center, in order to autonomously determine the focus area. Unfortunately, these methods often neglect to consider the broader context of the entire multimedia content. Consequently, the automatic selection of the focus area lacks precision, necessitating frequent manual intervention. Moreover, the existing methods are limited in their ability to select only a single object or area of focus within the multimedia content, thereby restricting their potential.

Therefore, it is crucial to develop a system or method that can address these limitations and enhance autofocus capabilities by utilizing an artificial intelligence (AI)-based autofocus technology.

Numerous prior art solutions exist that disclose methods and systems for providing focus functionality.

The existing prior art discloses about interactive inputs for a background task. The prior art further discloses about providing improved multitasking on user devices. The method involves detecting a non-touch gesture input received by a user device and associating the non-touch gesture input with an application running in a background. In one embodiment of the disclosure, the different focused application is running in a foreground. Furthermore, the method involves controlling the background application with the associated non-touch gesture input without affecting the foreground application.

However, the conventional art does not disclose about computing occupancy factor and popularity factor of each detected object to determine priority score. Further, the prior art is silent about identifying a suitable focus mode and a focus area mode for each selected object based on extracted attributes. It should be noted that the selected object refers to all the detected objects that have a priority score greater than or equal to a predefined threshold value. Additionally, the prior art is silent about applying the identified focus mode and the focus area mode on each selected object for providing the multimedia content.

Further, the prior art discloses continuous autofocus based on face detection and tracking. The prior art further discloses acquiring an image of a scene that includes one or more partial faces and/or out of focus faces and detecting one or more of the partial faces and/or out of focus faces within the digital image by applying classifiers trained on faces. In one embodiment of the disclosure, one or more sizes of the one or more out-of-focus faces and/or partial faces within the digital image are determined. Additionally, one or more respective depths to the out-of-focus faces and/or partial faces are determined based on their respective sizes within the digital image. Finally, one or more respective focus positions of the lens are adjusted to approximately focus at the determined depths. However, the conventional art does not disclose about computing occupancy factor and popularity factor of each detected object to determine priority score. Further, the prior art is silent about identifying a suitable focus mode and a focus area mode for each selected object based on extracted attributes. It should be noted that the selected object refers to all the detected objects that have a priority score greater than or equal to a predefined threshold value. Additionally, the prior art is silent about applying the identified focus mode and the focus area mode on each selected object for providing the multimedia content.

Therefore, in light of the foregoing discussion, there exists a need to overcome the aforementioned drawbacks associated with the existing system and method for optimizing auto-focus functionality for capturing the multimedia content.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a system and method for optimizing auto-focus functionality for capturing a multimedia content.

Additional aspects will be set forth in part in the description which follows and, in part, will be apparent from the description, or may be learned by practice of the presented embodiments.

In accordance with an aspect of the disclosure a method for optimizing auto-focus functionality for capturing a multimedia content is provided. The method includes detecting, by an object detection module, one or more objects in a preview frame of the multimedia content, performing, by a feature extraction module, a plurality of functions for extracting attributes of the detected one or more objects, computing, by a priority assignment module, occupancy factor and popularity factor of each detected object to determine priority score, identifying, by a focus identification module, a suitable focus mode and a focus area mode for each selected object based on extracted attributes, wherein the selected object includes all the detected objects that have priority score greater than or equal to a predefined threshold value, and applying, by a frame capture and combining module, the identified focus mode and the focus area mode on each selected object for providing the multimedia content.

The method further includes computing occupancy factor and popularity factor of each detected object to determine priority score. In one embodiment of the disclosure, the priority score is determined by combining a predefined percentage of each of the occupancy factor, the popularity factor, and the average brightness value of each detected object.

The occupancy factor of each detected object is computed by performing relative difference between the predicted occupancy percentage and the actual occupancy percentage, expressing the relative difference as a fraction of the predicted occupancy percentage, and subtracting this fraction from 1. The predicted occupancy is determined based on detected object and respective depth and the actual occupancy percentage is determined by utilizing ratio of number of pixels occupied by the object and total number of pixels. The popularity factor is computed by performing ratio of number of occurrences of the object in a specific type of environment or event in the frame to total number of frames that contain the specific type of environment or event.

The method further includes identifying a suitable focus mode and a focus area mode for each selected object based on extracted attributes. In one embodiment of the disclosure, the selected object includes all the detected objects that have priority score greater than or equal to a predefined threshold value.

Thereafter, the method includes applying the identified focus mode and the focus area mode on each selected object for providing the multimedia content.

In accordance with another aspect of the disclosure, a system for optimizing auto-focus functionality for capturing a multimedia content is provided. The system includes an object detection module for detecting one or more objects in a preview frame of the multimedia content, a feature extraction module for performing a plurality of functions for extracting attributes of the detected one or more objects, a priority assignment module for computing occupancy factor and popularity factor of each detected object to determine priority score, a focus identification module for identifying a suitable focus mode and a focus area mode for each selected object based on extracted attributes, wherein the selected object includes all the detected objects that have priority score greater than or equal to a predefined threshold value, and a frame capture and combining module, for applying the identified focus mode and the focus area mode on each selected object for providing the multimedia content.

In one embodiment of the disclosure, the popularity factor is computed by a popularity factor calculation sub-module which is trained by utilizing mapping of the object and respective environment with the popularity factor. The mapping is obtained by performing operations that includes obtaining a plurality of frames from a database and detecting area of focus within obtained frame. The database includes a plurality of frames in conjunction with respective type of environment or event. The operations further includes detecting one or more objects in each detected focused area and performing grouping of similar objects, computing popularity factor of each object, and mapping the object and type of environment or event with the computed popularity factor.

The system further includes a focus identification module for identifying a suitable focus mode and a focus area mode for each selected object based on extracted attributes. In one embodiment of the disclosure, the selected object includes all the detected objects that have priority score greater than or equal to a predefined threshold value. Thereafter, the system includes a frame capture and combining module for applying the identified focus mode and the focus area mode on each selected object for providing the multimedia content.

In an embodiment of the disclosure, the multimedia content capturing device captures multiple frames, with each frame focusing on a selected object using the respective identified focus mode and the focus area mode and combines all the captured frames to provide the multimedia content.

In accordance with another aspect of the disclosure, one or more non-transitory computer-readable storage media storing one or more computer programs including computer-executable instruction that, when executed by one or more processors of an electronic device individually or collectively, cause the electronic device to perform operations for optimizing auto-focus functionality for capturing a multimedia content are provided. The operations include detecting, by an object detection module, one or more objects in a preview frame of the multimedia content, performing, by a feature extraction module, a plurality of functions for extracting attributes of the detected one or more objects, computing, by a priority assignment module, occupancy factor and popularity factor of each detected object to determine priority score, identifying, by a focus identification module, a suitable focus mode and a focus area mode for each selected object based on extracted attributes, wherein the selected object includes all the detected objects that have priority score greater than or equal to a predefined threshold value, and applying, by a frame capture and combining module, the identified focus mode and the focus area mode on each selected object for providing the multimedia content.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a flowchart illustrating a method for optimizing auto-focus functionality for capturing a multimedia content according to an embodiment of the disclosure;

FIG. 2 depicts a block diagram of a system performing a method for optimizing auto-focus functionality for capturing a multimedia content according to an embodiment of the disclosure;

FIG. 3 depicts a pictorial representation of an object detection module to detect one or more objects in a preview frame of a multimedia content capturing device according to an embodiment of the disclosure;

FIG. 4 depicts a block diagram of a feature extraction module according to an embodiment of the disclosure;

FIG. 5 depicts a pictorial representation of depth detection to extract depth of each detected object according to an embodiment of the disclosure;

FIG. 6 depicts a pictorial representation of brightness detection to extract brightness of each detected object according to an embodiment of the disclosure;

FIG. 7A is a flowchart illustrating a method for detecting motion of each detected object according to an embodiment of the disclosure;

FIG. 7B depicts a pictorial representation of motion detection to extract motion of each detected object according to an embodiment of the disclosure;

FIG. 8 depicts a block diagram of priority assignment module according to an embodiment of the disclosure;

FIG. 9 is a flowchart illustrating a method of obtaining mapping to train occupancy factor calculation sub-module according to an embodiment of the disclosure;

FIG. 10 is a flowchart illustrating a method of obtaining mapping to train popularity factor calculation sub-module according to an embodiment of the disclosure;

FIG. 11 depicts a pictorial representation of stacking mechanism used in a frame capture and combining module according to an embodiment of the disclosure; and

FIG. 12 depicts a use case of optimizing auto-focus functionality for capturing a multimedia content, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the spirit and scope of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Furthermore, in the description, references to “one embodiment” or “an embodiment” means that a particular feature, structure, or characteristic described in connection with the embodiment is included in at least one embodiment of the disclosure. The appearance of the phrase “in one embodiment” in various places in the specification is not necessarily referring to the same embodiment of the disclosure, nor are separate or alternative embodiments mutually exclusive of other embodiments. Further, the terms “a” and “an” used herein do not denote a limitation of quantity, but rather denote the presence of at least one of the referenced items. Moreover, various features are described which may be exhibited by some embodiments and not by others. Similarly, various requirements are described, which may be requirements for some embodiments but not for other embodiments.

Multimedia content capturing devices refer to devices that are specifically designed to capture various forms of multimedia content, such as images, videos, and screen events. These devices are equipped with sensors, lenses, and other components that enable the capture and recording of high-quality multimedia content. Examples of multimedia content capturing devices include at least but not limited to digital cameras, camcorders, smartphones, tablets, and webcams.

To capture multimedia contents, these multimedia content capturing devices utilizes autofocus (AF) modes, the autofocus area modes along with techniques related to depth of field, such as deep focus, shallow focus, and focus stacking. These techniques play a crucial role in capturing sharp and well-focused media content, ensuring that the captured multimedia content is of high quality and visually appealing.

The deep focus technique generally employs a large depth of field, meaning that the foreground, middle ground, and background all have an acceptable moderate sharpness. This technique is achieved by choosing a small aperture and a shorter focal length lens. However, the deep focus lacks the ability to produce finely sharp-focused images on a specific region since its purpose is to capture everything in the frame with moderate sharpness.

The shallow focus technique incorporates a small depth of field. In shallow focus, only one plane of the scene is in focus, while the rest is intentionally blurred. This effect can be achieved by widening the aperture, increasing the focal length of the lens, or bringing the camera closer to the subject. The shallow focus is often used to emphasize a particular part of the image over others. However, the shallow focus captures the frame with a single sharp focus area only, and doesn't focus in remaining areas of the frame. Furthermore, the multimedia content capturing devices may not able to select the preferred area of interest as focus automatically and hence may require manual intervention by user.

The focus stacking is used to achieve a deep depth of field by blending multiple images focused on different regions. By combining these images, a deeper depth of field can be obtained compared to what can be achieved with a single image. It should be noted that the focus stacking is particularly useful when multiple sharp focus areas are needed in the frame. However, this technique requires capturing frames with different focus areas separately and then combining them using a stacker tool. It does not happen simultaneously within the multimedia content capturing device. Additionally, manual tapping by the user is often required to select the focus object/area, and it does not automatically detect multiple objects or consider frame context.

Therefore, requires such a system and method that aims to automatically select multiple area of interest based on overall context of the frame, thereby capturing frames with multiple sharp-focus area. By incorporating the artificial intelligence and considering the complete frame's context, autofocus can be enhanced to provide more accurate and context-aware focusing capabilities.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

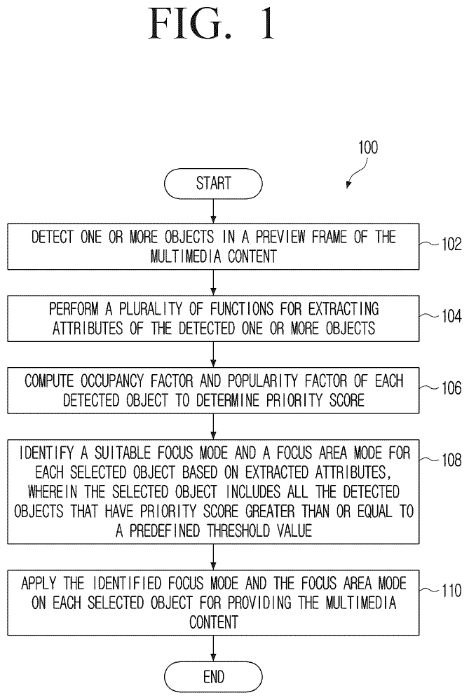

FIG. 1 is a flowchart illustrating a method 100 for optimizing auto-focus functionality for capturing a multimedia content according to an embodiment of the disclosure.

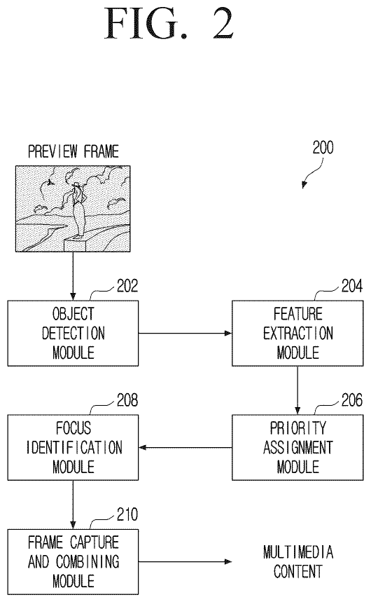

The method may be explained in conjunction with the system disclosed in FIG. 2. In the flow diagram, each block represents a module, segment, or portion of code that contains one or more executable instructions for implementing specific logical functions. It is important to note that in certain alternative implementations, the sequence of functions shown in the drawings may not occur exactly in the order indicated. For instance, two blocks displayed consecutively in FIG. 1 may be executed concurrently, or the blocks may be executed in reverse order depending on the specific functionality involved.

Any descriptions or blocks in the flowcharts should be understood as representing segments, modules, or portions of code that include executable instructions for implementing specific logical functions or operations in the process. Alternate implementations are also within the scope of the example embodiments of the disclosure, where functions may be executed out of order from what is shown or discussed. This includes the possibility of executing functions substantially concurrently or in reverse order, depending on the specific functionality involved.

Additionally, the process descriptions or blocks in the flowcharts should be understood as representing decisions made by a hardware structure, such as a state machine.

Referring to FIG. 1, the flow diagram starts at operation 102 and proceeds to operation 110.

At operation 102, one or more objects are detected in a preview frame of the multimedia content. In one embodiment of the disclosure, the one or more objects are detected using machine learning (ML)/artificial learning intelligence (AI) state of the art (SOTA) algorithms. Examples of SOTA algorithms in ML/AI may include, but not limited to, you only look once (YOLO), region-based convolutional neural network (faster R-CNN), single shot multibox detector (SSD), EfficientDet, and RetinaNet.

Successively, a plurality of functions is performed, at operation 104, for extracting attributes of the detected one or more objects. In one embodiment of the disclosure, the plurality of functions, including depth detection, brightness detection, and object motion detection, are performed to extract attributes, such as, but not limited to, depth of each detected object from lens of multimedia content capturing device, brightness, and motion of each object, respectively. The depth of each detected object is extracted by utilizing transfer learning in conjunction with a DenseNet convolutional neural network. The brightness of each object is extracted by performing operations which includes detecting color of reflected light from each detected object and converting the detected red, green, and blue (RGB) color to hue, saturation value (HSV) color, to determine the brightness of the object. The motion of each object is extracted by performing frame difference method.

Successively, occupancy factor and popularity factor of each detected object is computed, at operation 106, to determine priority score. In one embodiment of the disclosure, the occupancy factor of each detected object is computed by performing relative difference between the predicted occupancy percentage and the actual occupancy percentage, expressing the relative difference as a fraction of the predicted occupancy percentage, and subtracting this fraction from 1. The predicted occupancy is determined based on detected object and its respective depth, while the actual occupancy percentage is determined by utilizing ratio of number of pixels occupied by the object and total number of pixels.

The popularity factor is computed by calculating ratio of number of occurrences of the object in a specific type of environment or event in the frame to total number of frames that contain the specific type of environment or event. The priority score is determined by combining the predefined percentage of each of the occupancy factor, the popularity factor, and the average brightness value of each detected object.

Successively, a suitable focus mode and a focus area mode are identified for each selected object based on extracted attributes, at operation 108. In one embodiment of the disclosure, the selected object includes all the detected objects that have priority score greater than or equal to a predefined threshold value.

It should be noted that the autofocus (AF) modes and the autofocus area offer flexibility to change focus settings based on the specific requirements of the scene and shooting conditions.

At present, there are three primary autofocus modes: single autofocus mode, continuous autofocus mode, and hybrid autofocus mode.

The single autofocus mode is designed to focus on a specific object of interest. This mode is ideal for capturing static objects, such as portraits or macro photography, where there is no need for constant tracking or covering a wide area. Once the multimedia content capturing device acquires focus on the object, it remains locked regardless of any subsequent movement. While this mode ensures precise focus on stationary objects, it may lack adaptability needed for the objects in motion.

On the other hand, the continuous autofocus mode is specifically intended for capturing objects that are in constant motion. With this mode activated, the multimedia content capturing device continuously tracks the object within the frame, adjusting the focus as needed. However, due to dynamic nature of moving objects, this mode may result in frequently acquiring and losing the focus. Factors, such as the object's movements, the lens's focusing speed, shallowness of depth, and lighting conditions may influence performance of the continuous autofocus mode. It is particularly useful in situations like sports photography or wildlife photography, where maintaining focus on rapidly moving objects is crucial.

The hybrid autofocus mode combines the best of both worlds by offering a versatile solution for uncertain shooting scenarios. When the multimedia content capturing device detects object in motion, it automatically switches to continuous autofocus mode to track the object in motion. Once the object pauses or the motion subsides, the multimedia content capturing device seamlessly transitions back to the single autofocus mode. This mode is particularly handy in challenging situations, such as capturing wildlife or photographing children, who can exhibit sudden bursts of speed or unpredictable movements.

The autofocus area modes refer to different options available on the multimedia content capturing devices that determine how and where the device focuses within a frame. At present, three autofocus area modes, such as a single point autofocus area mode, dynamic autofocus area mode, and a group autofocus area mode are present.

The single point AF area mode enables selecting a single focus point manually within the scene. When the object is framed over this point, the multimedia content capturing device ensures sharpness and preserves the clarity of frame. Advanced multimedia content capturing devices provide a larger number of focus points, allowing for more precise selection of a specific single point. This mode is particularly useful for capturing still objects, such as portraits or macro photography, where there is no need for extensive tracking or covering a wide area.

In contrast, the dynamic AF area mode expands upon the capabilities of the single point AF area mode by incorporating surrounding focus points. Once the focus point is manually selected, if the object moves, the multimedia content capturing device utilizes both the selected point and the surrounding points to maintain sharp focus. The number of focus points available in this mode varies across different multimedia content capturing devices, typically ranging from 9 to 51, depending on sensor size and type. It should be noted that the dynamic AF area mode is particularly effective in wildlife and sports/action photography, where the objects are in constant motion and require continuous tracking for optimal focus.

Lastly, the group AF area mode offers a specific autofocus area with a smaller count of autofocus points instead of a single point. This mode ensures autofocus accuracy when a single AF point is insufficient to single out a particular subject or zone. Examples of situations where the group AF area mode is used include wildlife and sports photography, where the objects are often found in groups within a specific area. Additionally, it serves as an ideal focus area mode for group shots in portraiture, to maintain focus on multiple objects within the frame.

Thereafter, the identified focus mode and the focus area mode are applied, at operation 110 on each selected object for providing the multimedia content. It should be noted that the multimedia content capturing device captures multiple frames, with each frame focusing on a selected object using the respective identified focus mode and the focus area mode. All the captured frames are then combined to provide the multimedia content.

FIG. 2 is a block diagram of a system performing method for optimizing auto-focus functionality for capturing a multimedia content according to an embodiment of the disclosure. In an embodiment of the disclosure, the multimedia content in the disclosure may include a frame of image or video captured using the multimedia content capturing device, such as a mobile device with a camera application. In another embodiment of the disclosure, the multimedia content capturing device may be any other electronic device equipped with a camera.

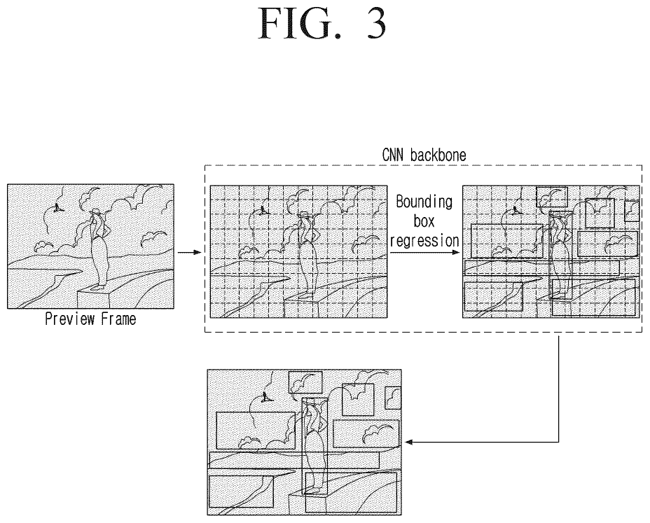

Referring to FIG. 2, a system 200 comprises an object detection module 202 that is configured to detect one or more objects in a preview frame of the multimedia content. The preview frame refers to a specific frame or image that is displayed or selected as a preview of a larger multimedia content, such as a video or image and often used to provide a glimpse or representation of the content before it is played or viewed in its entirety. The preview frame can be manually selected or automatically generated, depending on the platform or application. The working of the object detection module 202 is explained in FIG. 3.

FIG. 3 is a pictorial representation of working of an object detection module 202 according to an embodiment of the disclosure.

Referring to FIG. 3, it should be noted that the object detection module utilizes a convolution neural network for one or more objects detection. As depicted, detection of one or more objects in the preview frame involves a process of receiving the preview frame from the multimedia content capturing device, dividing the received frame into grids. Subsequently, bounding box regression is performed to predict the bounding boxes and their corresponding class probabilities for the detected objects. It should be noted that the bounding box is an outline that is used to highlight and define location of the object within the frame. The bounding box is represented by several attributes, such as:

Width (bw) and Height (bh): These attributes specify size of the bounding box, representing width and height of the object being detected.

Bounding box center (bx, by): These attributes indicate coordinates of the center point of the bounding box within the frame.

Class of object: This attribute identifies category or class of the object contained within the bounding box. Examples of object classes include person, car, traffic light, or the like.

Probability/Confidence (Pc): This attribute represents confidence or probability of detecting the object within the bounding box. It is typically calculated using the intersection over union (IoU) value between the predicted bounding box and the actual bounding box (ground truth box).

In the context of object detection using a grid-based approach, each prediction from a grid cell is structured as C (which is number of classes)+B (which is number of predicted bounding boxes)*5. The multiplication by 5 is due to the inclusion of the bounding box attributes (bx, by, bw, bh, confidence) for each predicted box.

As the frame is divided into S×S grids, so there are S×S grid cells in each frame, the overall prediction of the model is represented as a tensor of shape S×S×(C+B*5). This tensor contains the predictions for each grid cell, including the class probabilities and bounding box attributes, enabling the model to detect and localize objects within the frame.

Finally, non-max suppression using intersection over union is employed to detect different objects that are present within the frame. This approach allows for accurate and efficient object detection within the preview frame, avoiding the issue of a single object being detected multiple times by different bounding boxes.

The non-max suppression process for the preview image begins by selecting the bounding box with highest probability, such as in the preview frame the Water body box with a probability of 0.93. It then examines the remaining bounding boxes and checks for a high intersection over union (IoU) value with the selected box. The IoU is calculated by dividing area of intersection by area of union between two bounding boxes. In this case, no other boxes are found to have a high IoU with the water body box, indicating that it is the only box detecting the water body.

Next, the process moves on to the next highest probability box, which is the Human box with a probability of 0.91. It then identifies other bounding boxes with a higher IoU value compared to the Human box and suppresses them. For example, the Human box with a probability of 0.75 is suppressed since it has a higher IoU with the selected Human box. This operation ensures that only one bounding box is retained for the detected human.

Similarly, the non-max suppression procedure continues with the Bird boxes. The box with the highest confidence score, Bird 0.85, is kept, while the Bird box with a confidence score of 0.68 is suppressed because it detects the same bird and has a lower confidence score.

In many cases, there are similar subjects that are located very close to each other and can be considered as one group of that object. For example, in the preview image, multiple clouds are observed, but since they are of a similar type, they may be grouped together as one patch of clouds.

Ultimately, the non-max suppression algorithm ensures that each object is detected by only one bounding box with the highest confidence score, while suppressing other bounding boxes with lower confidence scores that correspond to the same object. This helps to eliminate redundant detections and provide a cleaner and more accurate output.

Further loss function, such as regression loss, confidence loss and classification loss may be utilized by the object detection module 202. It should be noted that the regression loss is a type of loss function used in object detection tasks to measure the difference between predicted bounding box coordinates and the ground truth bounding box coordinates. It helps in refining the predicted bounding box positions to align them more accurately with the actual objects in the image.

The confidence loss is a loss function that evaluates the confidence or certainty of the object detection model in predicting the presence or absence of an object within a bounding box. It penalizes incorrect predictions and encourages the model to assign higher confidence scores to accurate detections.

The classification loss is used to measure the discrepancy between predicted class labels and the ground truth labels for the objects within the bounding boxes. It helps in training the model to correctly classify the detected objects into their respective categories or classes.

By incorporating these loss functions into the object detection module, the system aims to improve the accuracy and performance of the object detection process. These loss functions contribute to the optimization of the model during the training phase, allowing it to learn and make more precise predictions about the objects present in the input data.

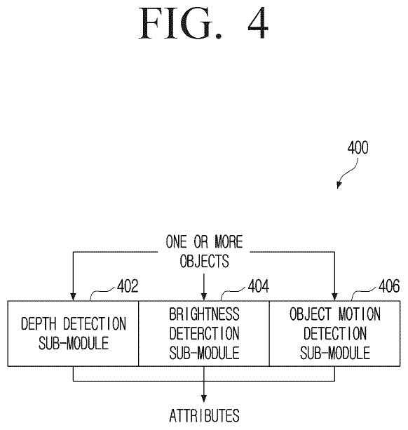

The system 200 further comprises a feature extraction module 204 that is configured to perform a plurality of functions for extracting attributes of the detected one or more objects, which is explained in FIG. 4.

FIG. 4 is a block diagram 400 of a feature extraction module 204 according to an embodiment of the disclosure.

Referring to FIG. 4, the feature extraction module 204 comprises a depth detection sub-module 402, a brightness detection sub-module 404, and an object motion detection sub-module 406. Each and every sub-module receives one or more detected objects and provides attributes at the output for each detected object. In one embodiment of the disclosure, the depth detection sub-module 402 is configured to provide depth of each detected object from lens of multimedia content capturing device on receiving the one of more detected objects. In this process, a depth map is created for each two-dimensional (2D) frame captured by the multimedia content capturing device. The depth map assigns a distance in meters to each pixel in the image, representing its depth or distance from the multimedia content capturing device.

To achieve this, the depth detection sub-module 402 utilizes a transfer learning by repurposing high-performing pre-trained networks, such as DenseNet (Densely-connected convolutional neural network). It should be noted that the DenseNet is originally designed for image classification tasks, but here in this disclosure it is adapted as a deep feature encoder for depth estimation.

The transfer learning provides an advantage of enabling a more modular architecture, where advancements made in one domain can be easily transferred to another domain. The depth detection sub-module 402 heavily relies on the concept of transfer learning by utilizing image encoders originally designed for image classification to help address the depth detection problem.

The transfer learning enables to capitalize the knowledge and representations learned by the pre-trained image encoders, which ultimately helps to recognize and extract meaningful features from the frame more effectively. By avoiding the need to start the training process from scratch, the time and computational resources can be saved while still achieving good performance on depth detection.

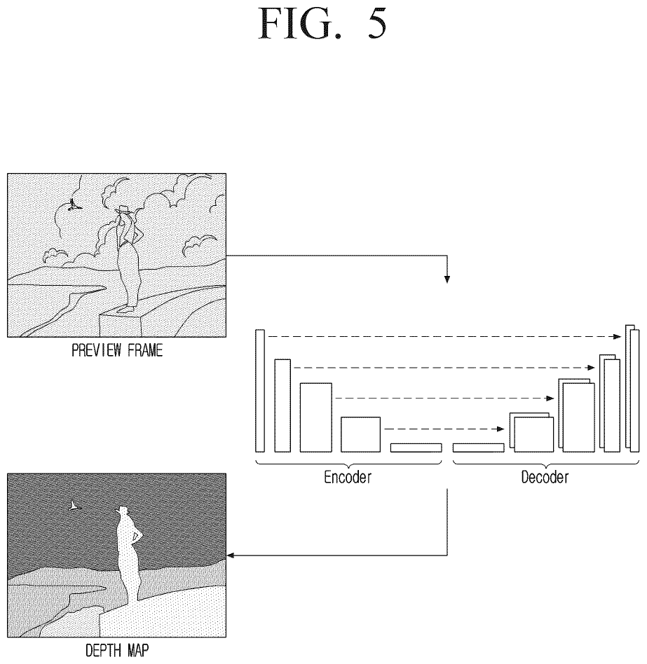

The depth detection sub-module 402 is trained on available datasets that contain media contents and their corresponding depth maps. This process helps the network learn to extract meaningful features from the input images and generate accurate depth detection. The depth detection sub-module 402 is explained in FIG. 5.

FIG. 5 illustrates depth detection module according to an embodiment of the disclosure.

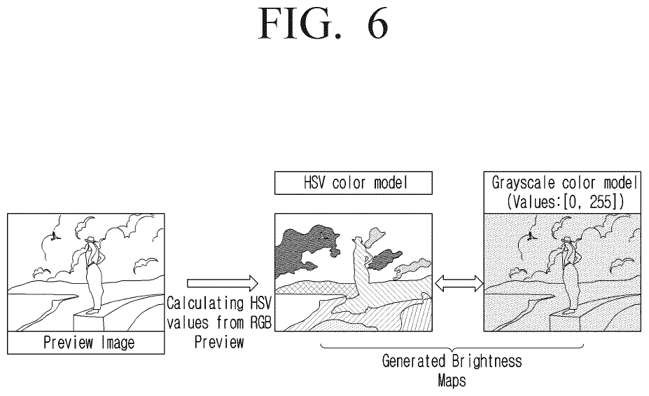

FIG. 6 depicts a pictorial representation brightness detection to extract brightness of each detected object according to an embodiment of the disclosure.

Referring to FIGS. 5 and 6, the encoder and decoder with skip connections may be used for depth detection.

The encoder in the depth estimation model is responsible for converting the input RGB image into a feature vector. This is achieved by utilizing the DenseNet-169 network, which has been pre-trained on the ImageNet dataset, primarily designed for image classification tasks. It should be noted that DenseNet-169 offers better performance compared to alternatives, such as DenseNet-121 and ResNet50 when evaluating results using metrics like average relative error (REL) and root mean square error (RMSE) for actual to predicted depth maps.

On the other hand, the decoder in the model consists of basic blocks of convolutional layers. It operates on the concatenation of the upsampled output from the previous block with the corresponding block in the encoder, which has been upsampled using bilinear interpolation to have the same spatial size.

The decoder is responsible for transforming the feature vector extracted by the encoder into a depth map. By utilizing the upsampled features from the encoder and applying convolutional layers within the decoder, the module can gradually reconstruct the spatial details and depth information from the original image.

The depth detection sub-module 402 further utilizes a loss function to balance between reconstructing depth images by minimizing difference of the depth values while also penalizing distortions of high frequency details, the loss function is disclosed below.

$$L ( y , \hat{y} ) = λ {L}_{depth} ( y , \hat{y} ) + {L}_{grad} ( y , \hat{y} ) + {L}_{SSIM} ( y , \hat{y} )$$

$$where :$$

$${L}_{depth} ( y , \hat{y} ) = \frac{1}{n} {\sum }^{n} \vert ( {y}_{p} - {\hat{y}}_{p} ) \vert +$$

$${L}_{grad} ( y , \hat{y} ) = \frac{1}{n} {{\sum }^{n}}_{p} \vert {g}_{x} ( {y}_{p} - {\hat{y}}_{p} ) \vert + \vert {g}_{y} ( {y}_{p} - {\hat{y}}_{p} ) \vert$$

$${L}_{SSIM} ( y , \hat{y} ) = \frac{1 - SSIM ( y , \hat{y} )}{2}$$

y=>Ground Truth Depth Map, ŷ=>Predicted Depth Map Network
L_{depth}(y,ŷ)=>Loss Defined on Depth Map
L_{grad}(y,ŷ)=>Loss Defined on the Image Gradient of the Depth
L_{SSIM}(y,ŷ)=>Loss Defined for Image Reconstruction Task

The brightness detection sub-module 404 is configured to detect color of reflected light from each one or more detected object. In one embodiment of the disclosure, brightness detection sub-module 404 employs RGB color sensors for detection of the color. The RGB color sensors generally measure intensity of reflected light from detected object and differentiate the primary colors like red, green, and blue. It should be noted that when an object is illuminated with light that contains RGB components, the color of the reflected light depend on the color of the object. For example, if the object is red, the reflected light may be red. For a yellow object, the reflected light may be a combination of red and green, and if the object is white all three components may be reflected.

The brightness detection sub-module 404 is further configured to convert the detected RGB color to hue, saturation value (HSV) color, to determine the brightness. In one embodiment of the disclosure, the brightness detection sub-module 404 employs a detection sub-module for converting the RGB to HSV color. The HSV color space is often preferred over RGB color space in applications involving varying illumination levels, such as thresholding and masking, due to its superior performance.

The HSV color space separates the color information into three components: Hue, Saturation, and Value. Unlike RGB, where color information is represented as a combination of red, green, and blue channels, the HSV provides a more intuitive representation of color. The Hue component represents the color itself, the Saturation component represents the intensity or purity of the color, and the Value component represents the brightness or lightness of the color. As depicted in FIG. 6, the HSV color model is calculated from the RGB preview frame. In an embodiment of the disclosure, the HSV values is calculated from the RGB preview frame by using the following equations:

$$C max = max ( {R}^{′} , {G}^{′} , {B}^{′} ) \\ C min = min ( {R}^{′} , {G}^{′} , {B}^{′} ) \\ Δ = C max - C min$$

Wherein, R′=R/255, G′=G/255, B′=B/255

### Hue Calculation:

$$H = \{ \begin{matrix}0 ° & Δ = 0 \\ 60 ° \times ( \frac{{G}^{′} - {B}^{′}}{Δ} mod 6 ) , & {C}_{max} = {R}^{′} \\ 60 ° \times ( \frac{{B}^{′} - {R}^{′}}{Δ} + 2 ) , & {C}_{max} = {G}^{′} \\ 60 ° \times ( \frac{{R}^{′} - {G}^{′}}{Δ} + 4 ) , & {C}_{max} = {B}^{′}\end{matrix}$$

### Saturation Calculation:

$$S = ( \begin{matrix}0 , & C max = 0 \\ \frac{Δ}{{C}_{max}} , & C max \neq 0\end{matrix} )$$

### Value or Brightness Calculation:

$$V = C max$$

In another embodiment of the disclosure, the grayscale color model of the preview image may be derived from the HSV color model or vice versa. The values in the gray scale color model and the HSV color model are then used to generate the brightness map. In an embodiment of the disclosure, the brightness map, the brightness value of each pixel of the preview frame may lie in the range of [0, 255].

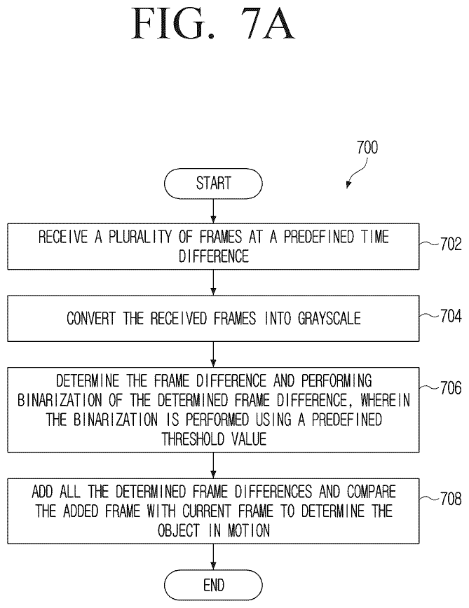

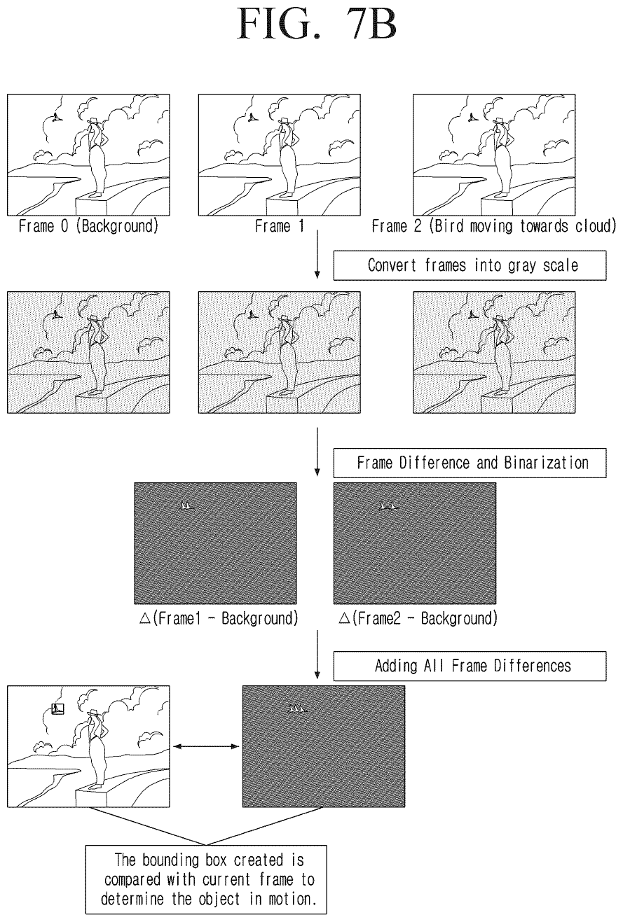

The object motion detection sub-module 406 is configured to detect motion of each one or more detected objects. In one embodiment of the disclosure, the motion of each object is detected by performing frame difference method, which is explained in FIGS. 7A and 7B. The frame difference method is a technique used to detect a moving object from a sequence of frames captured by the multimedia content capturing device. This method relies on pixel-based differences between consecutive frames to identify areas where motion has occurred, allowing for the detection and segmentation of the moving object. In another embodiment of the disclosure, Background subtraction technique may be used by the object motion detection sub-module 406 to detect motion of each one or more detected objects. The background subtraction technique is used to model and extract the background from pixels by using different filters including approximate median filters, temporal median filters, or the like. This technique generally takes the first frame as a background frame, which is then used to compare incoming frames captured by the multimedia content capturing device and form a model for foreground detection.

FIG. 7A is a flowchart 700 illustrating a method for detecting motion of each detected object according to an embodiment of the disclosure.

Referring to FIG. 7A, the method includes receiving a plurality of frames at a predefined time difference, at operation 702.

Successively, the received frames are converted into grayscale, at operation 704. In an embodiment of the disclosure, the received RGB frame is converted to grayscale by using the following equation:

$$Y = 0.299 * R + 0.587 * G + 0.114 * B$$

It should be noted that when frames are converted into grayscale, it means that the color information of each frame is removed, and the resulting image consists of shades of gray. In the grayscale image, each pixel is represented by a single value that corresponds to its brightness or intensity level. This conversion simplifies the frame to a single channel, focusing solely on the intensity information rather than color. The process of converting frames into grayscale involves mapping the original color values of each pixel to a corresponding grayscale value. This mapping is typically done by taking a weighted average of the red, green, and blue (RGB) color channels of the original image. The resulting grayscale value represents the overall brightness of the pixel.

Successively, the frame difference is determined and binarization of the determined frame difference is performed, at operation 706. The frame difference is determined by utilizing the following equation:

$$I d ( k , k + 1 ) = \vert Ik + 1 - Ik \vert$$

Wherein, Ik is the value of the kth frame, Ik+1 is the value of the (k+1)^{th} frame.

In one embodiment of the disclosure, the binarization is performed using a predefined threshold value.

For binarization of frame difference values, the difference values are converted into binary values using a threshold. In an embodiment of the disclosure, the value of the threshold is defined within 15% of the range to observed pixel intensity, i.e., 40 255.

$$Binarization ( Id ( k , k + 1 ) ) = 1 , Diff >= Threshold = 0 , Diff < Threshold$$

The threshold value plays a crucial role in the frame difference method and background subtraction technique, as it determines sensitivity of detecting changes in pixel intensity. Selecting an appropriate threshold value is important to balance between detecting true motion and minimizing false detections.

If the threshold value is set too small, it may lead to a large number of false change points being detected. This means that even small changes in pixel intensity can be considered as motion, resulting in a noisy and inaccurate segmentation of moving objects. On the other hand, if the threshold value is set too large, it may decrease the sensitivity to changes in movement. This may cause some genuine motion to be overlooked or not detected, resulting in a limited scope of detecting actual moving objects.

Thereafter, all the determined frame differences are added and the added frame is compared with current frame to determine the object in motion, at operation 708.

FIG. 7B is a pictorial representation of motion detection to extract motion of each detected object according to an embodiment of the disclosure.

Referring to FIG. 7B, Frame 0 (background), frame 1, and frame 2 are received by the object motion detection sub-module 406. In Frame 2, the bird is observed to be moving towards the cloud. On receiving these frames, conversion to grayscale is performed and the frame difference is calculated by subtracting the background from Frame 1 and Frame 2 respectively, resulting in (Frame 1—background) and (Frame 2—background). To identify the moving objects, binarization is performed by applying the threshold value of 15%. This process converts the grayscale frame differences into binary images, where the pixels are classified as either foreground (moving objects) or background. Thereafter, these two frame differences are added which isolates the birds as the only moving objects. To clearly delineate the birds, bounding box is created around them in the final difference frame. The bounding box serves as visual marker that encapsulates the region of interest corresponding to the birds' positions. By comparing this bounding box with previously detected objects, the presence of the object in motion may be confirmed. This matching process helps to validate identification of the moving birds, ensuring that they are accurately detected and distinguished from other objects or background elements.

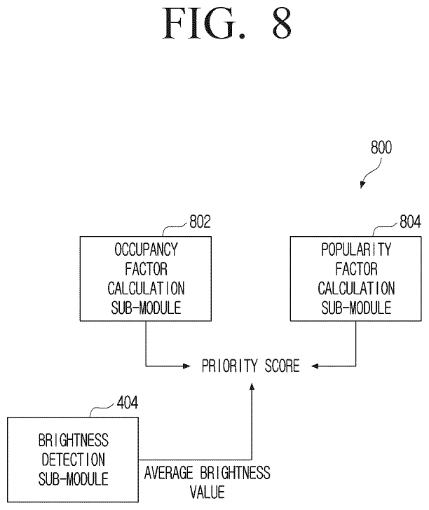

The system 200 further comprises a priority assignment module 206 that is configured to compute occupancy factor and popularity factor of each detected object to determine priority score. The priority assignment module 206 is explained in FIG. 8.

FIG. 8 is a block diagram 800 of a priority assignment module according to an embodiment of the disclosure.

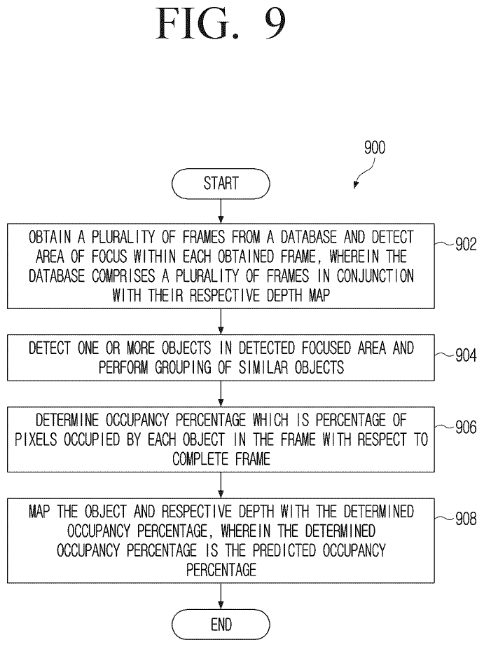

Referring to FIG. 8, the priority assignment module 206 comprises an occupancy factor calculation sub-module 802 and a popularity factor calculation sub-module 804. The occupancy factor of each detected object is computed by performing relative difference between the predicted occupancy percentage and the actual occupancy percentage, expressing the relative difference as a fraction of the predicted occupancy percentage, and subtracting this fraction from 1. The predicted occupancy is determined based on detected object and respective depth and the actual occupancy percentage is determined by utilizing ratio of number of pixels occupied by the object and total number of pixels. It should be noted that to provide the occupancy factor of each detected object by the occupancy factor calculation sub-module 802, the sub-module is required to be trained by utilizing mapping of each object and respective depth with predicted occupancy percentage, the mapping may be obtained by performing a method, which is explained in FIG. 9.

FIG. 9 is a flowchart 900 illustrating a method of mapping to train an occupancy factor calculation sub-module according to an embodiment of the disclosure.

Referring to FIG. 9, the method comprises obtaining a plurality of frames from a database and detecting area of focus within each obtained frame, at operation 902. The database may comprise a plurality of frames in conjunction with their respective depth map. In an embodiment of the disclosure, the sub-module utilizes a Laplacian filter for detecting area of focus by enhancing features with sharp discontinuity, such as significant changes in contrast.

The Laplacian filter is a commonly used linear differential operator that approximates the second derivative. By applying this filter to the frame, the focus detection sub-module highlights regions of rapid intensity change. This method of enhancement is known as a second derivative method, as it utilizes the second derivative of the frame to accentuate areas with sharp changes in intensity.

The below equation is used to perform the Laplacian filtering operation for focus detection:

$$∇ \cdot ∇ f = {∇}^{2} f = \frac{{\partial }^{2} f}{{\partial }^{2} x} + \frac{{\partial }^{2} f}{{\partial }^{2} y}$$

Wherein, f denotes the frame.

The method further comprises detecting one or more objects in detected focused area and performing grouping of similar objects, at operation 904. The occupancy factor calculation sub-module 802 utilizes specific algorithms or techniques to analyze the focused area and identify objects based on their characteristics, such as shape, color, or texture.

The occupancy factor calculation sub-module 802 further utilizes a random forest algorithm to learn and determine which objects should be grouped together at each stage of the hierarchy. The random forest algorithm is a powerful machine learning technique used for classification and regression tasks. It is particularly effective in scenarios where there are multiple features or variables that can influence the outcome. During the training process, the random forest algorithm learns patterns and relationships between the input features and the corresponding object labels. It considers various features, such as shape, color, texture, or any other relevant characteristics that can help distinguish different objects.

The method further comprises determining occupancy percentage which is percentage of pixels occupied by each object in the frame with respect to complete frame, at operation 906. Thereafter, the method comprises mapping the object and respective depth with the determined occupancy percentage, at operation 908. It should be noted that the determined occupancy percentage is the predicted occupancy percentage. The occupancy factor calculation sub-module 802 predicts occupancy percentage for each one or more detected objects from the object detection module 202 and their respective depth maps from the depth detection sub-module 402.

For example, for Input: {Object, Depth map of object}→Output: {Predicted Occupancy percentage}

Using the above predicted occupancy percentage, an occupancy factor is defined for each one or more detected objects based on predicted occupancy percentage and actual occupancy percentage of the object in current frame.

$$Occupancy factor ( OF ) = 1 - ( PO - AO ) / PO , if AO < PO = 1 , if AO >= PO$$

Wherein, PO=Predicted occupancy percentage and AO=Actual occupancy percentage=Number of pixels (area) occupied by the object/Total number of pixels.

It should be noted that the weightage of the Occupancy factor may be used for calculating the final priorities of detected objects.

In an embodiment of the disclosure, for object “Human” detected by the object detection module 202 and depth=20 m detected by the depth detection sub-module 402 in the preview frame.

$$Predicted occupancy percentage ( object : Human , Depth : 20 m ) = 7.55 \% \\ Calculated actual occupancy percentage ( object : Human ) = 6.94 \% \\ Occupancy factor of the object ( Human ) in the frame = 1 - ( PO - AO ) / PO , if AO < PO = 1 - ( 7. 55 - 6.94 ) / 7.55 = 1 - 0.08 = 0.92$$

Similarly, in case object “Bird” detected by the object detection module 202 and a depth of 220 m detected by the depth detection sub-module 402 in the preview frame,

$$Predicted occupancy percentage ( object : Bird , Depth : 220 m ) = 2. \% and \\ Calculated actual occupancy percentage ( object : Birds ) = 0.92 \% \\ Occupancy factor of the object ( Bird ) in the frame = 1 - ( PO - AO ) / PO , if AO < PO = 1 - ( 2. - 0.92 ) / 2 = 1 - 0.54 = 0.46$$

Similarly, in case object “Hills” detected by the object detection module 202 and a depth of 6500 m detected by the depth detection sub-module 402 in the preview frame,

$$Predicted occupancy percentage ( object : Hills , Depth : 6500 m ) = 11.05 \% \\ Calculated actual occupancy percentage ( object : Hills ) = 11.11 \% \\ Occupancy factor of the object ( Hills ) in the frame = 1 , if AO < PO$$

Similarly, the occupancy factor of all the detected objects may be calculated.

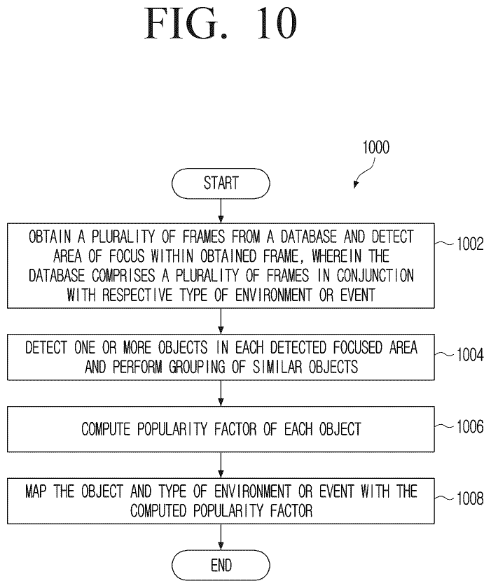

The popularity factor calculation sub-module 804 is configured to compute popularity factor of each one or more detected objects. It should be noted that to provide the popularity factor of each detected object by the popularity factor calculation sub-module 804, the sub-module is required to be trained by utilizing mapping of the object and respective environment with the popularity factor, the mapping may be obtained by performing a method, which is explained in FIG. 10.

FIG. 10 is a flowchart 1000 illustrating a method of mapping to train a popularity factor calculation sub-module is according to an embodiment of the disclosure.

Referring to FIG. 10, the method comprises obtaining a plurality of frames from a database and detecting area of focus within each obtained frame, at operation 1002. The database may comprise a plurality of frames in conjunction with their respective type of environment or event. In an embodiment of the disclosure, the sub-module utilizes a Laplacian filter for detecting area of focus by enhancing features with sharp discontinuity, such as significant changes in contrast.

The method further comprises detecting one or more objects in detected focused area and performing grouping of similar objects, at operation 1004. The popularity factor calculation sub-module 804 utilizes specific algorithms or techniques to analyze the focused area and identify objects based on their characteristics.

The popularity factor calculation sub-module 804 further utilizes a random forest algorithm to learn and determine which objects should be grouped together at each stage of the hierarchy.

The method further comprises computing popularity factor of each object, at operation 1006. Thereafter, the method comprises mapping the object and type of environment or event with the computed popularity factor, at operation 1008. The popularity factor calculation sub-module 804 computes the popularity factor is by performing ratio of number of occurrences of the object in a specific type of environment or event in the frame to total number of frames that contain the specific type of environment or event.

First training mapping parameter for environment prediction is
Input: {Object}→Output: {Environment}

The second training mapping parameter for popularity factor prediction is
Input: {Object, Environment}→Output: {Popularity Factor}

Using the above training mapping parameter, the popularity factor is computed for each object detected in the preview frame.

In an embodiment of the disclosure,

$$Popularity Factor ( object : Human , Environmnt : Hillside beach = 0.72 \% , Popularity Factor ( object : Bird , Environmnt : Hillside beach = 0.68 \% , Popularity Factor ( object : Hills , Environmnt : Hillside beach = 0.91 \% ,$$

and

Similarly, popularity factor for other detected objects are computed.

The priority assignment module 206 on successfully determining the occupancy factor and popularity factor, determines the priority score by combining a predefined percentage of each of the occupancy factor, the popularity factor, and the average brightness value of each detected object. It should be noted that the priority assignment module 206 may obtain the brightness value of each detected object from the brightness detection sub-module 404. In an embodiment of the disclosure, the priority assignment module 206 determines the priority score using the equation shown below:

$$Priority score = 0.4 * Occupancy factor of the object ) + ( 0.4 * Popularity factor of the object ) + ( 0.2 * Average Brightness value of object$$

For example, for the preview frame,

$$Priority score [ Human ] = ( 0.4 * 0.92 ) + ( 0.4 * 0.72 ) + ( 0.2 * 0.52 ) = 0.76 \\ Priority score [ Bird ] = ( 0.4 * 0.46 ) + ( 0.4 * 0.68 ) + ( 0.2 * 0.6 ) = 0.58 \\ Priority score [ Hills ] = ( 0.4 * 1 ) + ( 0.4 * 0.91 ) + ( 0.2 * 0.21 ) = 0.81$$

Similarly, priority scores of all detected subjects may be calculated

The system 200 further comprises a focus identification module 208 that is configured to identify a suitable focus mode and a focus area mode for each selected object based on extracted attributes. In an embodiment of the disclosure, the selected object includes all the detected objects that have priority score greater than or equal to a predefined threshold value. In an embodiment of the disclosure, the selected object includes all the detected objects, such as birds, human, hills that have a priority score greater than or equal to the threshold value of 0.5. It should be noted that the focus identification module 208 identifies the suitable focus mode by considering whether the selected objects are static or in motion. If the selected objects are in motion, the focus identification module 208 identifies continuous autofocus mode to continuously track and keep the objects in focus. If the selected objects are static like human, cloud, hills, waterbody, the focus identification module 208 identifies a single autofocus mode.

Additionally, the focus identification module 208 identifies the suitable autofocus area mode by considering whether the selected objects are static, static objects in a group, or in motion. If the selected objects are in motion, the focus identification module 208 identifies dynamic autofocus area mode to continuously track and keep the object in focus. If the selected objects are static like human, waterbody, or the like, the focus identification module 208 identifies a single-point autofocus area mode. If the selected objects are static but in groups, such as cloud, hills, or the like, the focus identification module 208 identifies a group autofocus area mode.

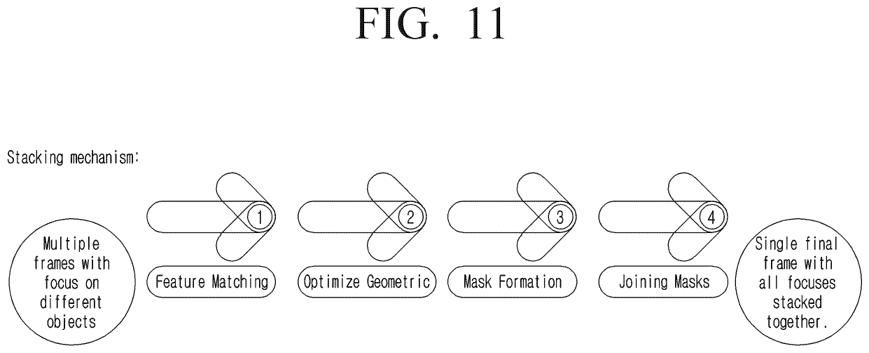

The system 200 further comprises a frame capture and combining module 210 that is configured apply the identified focus mode and the focus area mode on each selected object for providing the multimedia content. In an embodiment of the disclosure, the multimedia content capturing device captures multiple frames, with each frame focusing on a selected object using the respective identified focus mode and the focus area mode and combines all the captured frames to provide the multimedia content. The frame capture and combining module 210 is explained in FIG. 11.

FIG. 11 is a pictorial representation of stacking mechanism used in a frame capture and combining module according to an embodiment of the disclosure.

Referring to FIG. 11, the frame capture and combining module 210 receives multiple frames focused on different objects and performs feature matching. In the feature mapping process, it is necessary for all frames to have equal exposure and saturation levels, achieved through bracketed exposures to create a high dynamic range (HDR) or fused exposure across all frames. Subsequently, geometric optimization is performed to align the maximum content in the same situation, ensuring a seamless synchronization of the captured frames. Subsequently, mask formation process is performed which involves creating masks for the different captured frames. It should be noted that the masking is the process of highlighting the sections that are in focus within a frame. Then, joining masks is performed which involves taking one frame as a base and combining the masks from different frames to bring together all the regions that are in focus into a single frame and thus provides a single frame with all focuses stacked together.

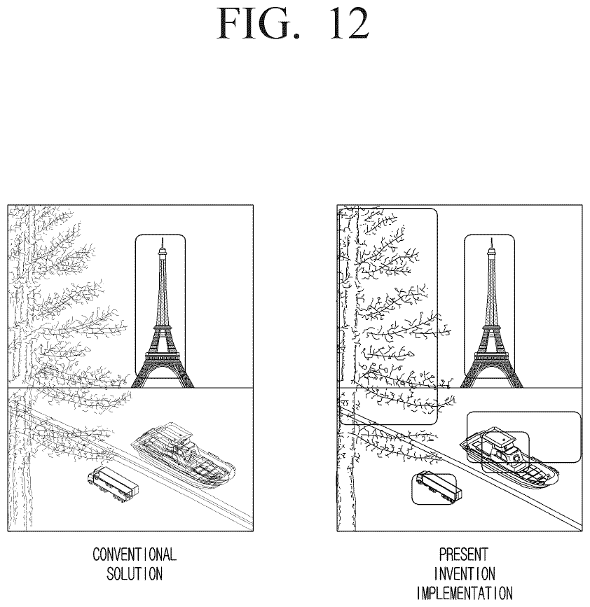

FIG. 12 is a use case of optimizing auto-focus functionality for capturing a multimedia content according to an embodiment of the disclosure.

Referring to FIG. 12, the depicted scenario highlights a limitation of the solution of the related art, which focuses only on a single object while neglecting other objects present in the preview frame. To overcome this limitation, the disclosure introduces a solution that automatically focuses on multiple objects based on overall context of the preview frame without requiring any manual intervention of the user and captures a final image having multiple sharp focus areas. This solution aims to address the issue of limited focus on a single object by providing the capability to automatically focus on multiple objects simultaneously, enhancing the overall quality and flexibility of multimedia content.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and the scope of the disclosure as defined by the appended claims and their equivalents.

What is claimed is:

1. A system for optimizing auto-focus functionality for capturing a multimedia content, the system comprising:
an object detection module for detecting one or more objects in a preview frame of the multimedia content;
a feature extraction module for performing a plurality of functions for extracting attributes of the detected one or more objects;
a priority assignment module for computing occupancy factor and popularity factor of each detected object to determine priority score;
a focus identification module for identifying a suitable focus mode and a focus area mode for each selected object based on extracted attributes, wherein the selected object includes all the detected objects that have priority score greater than or equal to a predefined threshold value; and
a frame capture and combining module, for applying the identified focus mode and the focus area mode on each selected object for providing the multimedia content.

2. The system of claim 1, wherein the plurality of functions, including depth detection, brightness detection, and object motion detection, are performed to extract attributes including at least one of depth of each detected object from lens of multimedia content capturing device, brightness, or motion of each object.

3. The system of claim 1, wherein the occupancy factor is computed by an occupancy factor calculation sub-module, which is trained by utilizing mapping of each object and respective depth with predicted occupancy percentage, the mapping is obtained by performing operations comprising:
obtaining a plurality of frames from a database and detecting area of focus within each obtained frame, wherein the database comprises a plurality of frames in conjunction with their respective depth map;
detecting one or more objects in detected focused area and performing grouping of similar objects;
determining occupancy percentage which is percentage of pixels occupied by each object in the frame with respect to complete frame; and
mapping the object and respective depth with the determined occupancy percentage, wherein the determined occupancy percentage is the predicted occupancy percentage.

4. The system of claim 1
wherein occupancy factor of each detected object is computed by performing relative difference between the predicted occupancy percentage and the actual occupancy percentage, expressing the relative difference as a fraction of the predicted occupancy percentage, and subtracting this fraction from 1, and
wherein the predicted occupancy is determined based on detected object and respective depth and the actual occupancy percentage is determined by utilizing ratio of number of pixels occupied by the object and total number of pixels.

5. The system of claim 1, wherein the popularity factor is computed by a popularity factor calculation sub-module, which is trained by utilizing mapping of the object and respective environment with the popularity factor, the mapping is obtained by performing operations comprising:
obtaining a plurality of frames from a database and detecting area of focus within obtained frame, wherein the database comprises a plurality of frames in conjunction with respective type of environment or event;
detecting one or more objects in each detected focused area and performing grouping of similar objects;
computing popularity factor of each object; and
mapping the object and type of environment or event with the computed popularity factor.

6. The system of claim 1, wherein the popularity factor is computing by performing ratio of number of occurrences of the object in a specific type of environment or event in the frame to total number of frames that contain the specific type of environment or event.

7. The system of claim 1, wherein the priority score is determined by combining a predefined percentage of each of the occupancy factor, the popularity factor, and an average brightness value of each detected object.

8. The system of claim 1, wherein the multimedia content capturing device captures multiple frames, with each frame focusing on a selected object using the respective identified focus mode and the focus area mode and combines all the captured frames to provide the multimedia content.

9. The system of claim 2,
wherein the motion of each object is extracted by performing a frame difference operation, and
wherein the frame difference operation comprises:
receiving a plurality of frames at a predefined time difference;
converting the received frames into grayscale;
determining the frame difference and performing binarization of the determined frame difference, wherein the binarization is performed using a predefined threshold value; and
adding all the determined frame differences and compare the added frame with current frame to determine the object in motion.

10. A method for optimizing auto-focus functionality for capturing a multimedia content, the method comprises:
detecting, by an object detection module, one or more objects in a preview frame of the multimedia content;
performing, by a feature extraction module, a plurality of functions for extracting attributes of the detected one or more objects;
computing, by a priority assignment module, occupancy factor and popularity factor of each detected object to determine priority score;
identifying, by a focus identification module, a suitable focus mode and a focus area mode for each selected object based on extracted attributes, wherein the selected object includes all the detected objects that have priority score greater than or equal to a predefined threshold value; and
applying, by a frame capture and combining module, the identified focus mode and the focus area mode on each selected object for providing the multimedia content.

11. The method of claim 10, wherein the plurality of functions, including depth detection, brightness detection, and object motion detection, are performed to extract attributes including at least one of depth of each detected object from lens of multimedia content capturing device, brightness, or motion of each object.

12. The method of claim 10, wherein the occupancy factor is computed by an occupancy factor calculation sub-module, which is trained by utilizing mapping of each object and respective depth with predicted occupancy percentage, the mapping is obtained by performing operations comprising:
obtaining a plurality of frames from a database and detecting area of focus within each obtained frame, wherein the database comprises a plurality of frames in conjunction with their respective depth map;
detecting one or more objects in detected focused area and performing grouping of similar objects;
determining occupancy percentage which is percentage of pixels occupied by each object in the frame with respect to complete frame; and
mapping the object and respective depth with the determined occupancy percentage, wherein the determined occupancy percentage is the predicted occupancy percentage.

13. The method of claim 10,
wherein the occupancy factor of each detected object is computed by performing relative difference between the predicted occupancy percentage and the actual occupancy percentage, expressing the relative difference as a fraction of the predicted occupancy percentage, and subtracting this fraction from 1, and
wherein the predicted occupancy is determined based on detected object and respective depth and the actual occupancy percentage is determined by utilizing ratio of number of pixels occupied by the object and total number of pixels.

14. The method of claim 10, wherein the popularity factor is computed by a popularity factor calculation sub-module, which is trained by utilizing mapping of the object and respective environment with the popularity factor, the mapping is obtained by performing operations comprising:
obtaining a plurality of frames from a database and detecting area of focus within obtained frame, wherein the database comprises a plurality of frames in conjunction with respective type of environment or event;
detecting one or more objects in each detected focused area and performing grouping of similar objects;
computing popularity factor of each object; and
mapping the object and type of environment or event with the computed popularity factor.

15. The method of claim 10, wherein the popularity factor is computed by performing ratio of number of occurrences of the object in a specific type of environment or event in the frame to total number of frames that contain the specific type of environment or event.

16. The method of claim 10, wherein the priority score is determined by combining a predefined percentage of each of the occupancy factor, the popularity factor, and an average brightness value of each detected object.

17. The method of claim 10, further comprising:
capturing, by the multimedia content capturing device, multiple frames, with each frame focusing on a selected object using the respective identified focus mode and the focus area mode; and
combining, by the multimedia content capturing device, all the captured frames to provide the multimedia content.

18. The method of claim 11, further comprising:
performing frame difference operation to extract the motion of each object,
wherein the frame difference operation comprises:
receiving a plurality of frames at a predefined time difference;
converting the received frames into grayscale;
determining the frame difference and performing binarization of the determined frame difference, wherein the binarization is performed using a predefined threshold value; and
adding all the determined frame differences and compare the added frame with current frame to determine the object in motion.

19. One or more non-transitory computer-readable storage media storing one or more computer programs including computer-executable instruction that, when executed by one or more processors of an electronic device individually or collectively, cause the electronic device to perform operations for optimizing auto-focus functionality for capturing a multimedia content, the operations comprising:
detecting, by an object detection module, one or more objects in a preview frame of the multimedia content;
performing, by a feature extraction module, a plurality of functions for extracting attributes of the detected one or more objects;
computing, by a priority assignment module, occupancy factor and popularity factor of each detected object to determine priority score;
identifying, by a focus identification module, a suitable focus mode and a focus area mode for each selected object based on extracted attributes, wherein the selected object includes all the detected objects that have priority score greater than or equal to a predefined threshold value; and
applying, by a frame capture and combining module, the identified focus mode and the focus area mode on each selected object for providing the multimedia content.

20. The one or more non-transitory computer-readable storage media of claim 19, wherein the plurality of functions, including depth detection, brightness detection, and object motion detection, are performed to extract attributes such as, but not limited to, depth of each detected object from lens of multimedia content capturing device, brightness, and motion of each object, respectively.
